(19) United States
(12) Patent Application Publication
(10) Pub. No.: US 2010/0151749 A1
(43) Pub. Date: Jun. 17, 2010

(54) DC power output insert connector assembly of power supply

(75) Inventor: Huang Cheng Po, Taipei (TW)

Correspondence Address: BACON & THOMAS, PLLC, 625 SLATERS LANE, FOURTH FLOOR, ALEXANDRIA, VA, 22314-1176, US

(73) Assignee: ENERMAX TECHNOLOGY CORPORATION, Taoyuan County (TW)

(21) Appl. No.: 12/314,633

(22) Filed: Dec. 15, 2008

(51) Int. Cl. H01R 13/02

(52) U.S. Cl. 439/884

(57) ABSTRACT

A DC power output insert connector assembly of a power supply includes: a fixed base; insert connectors coupled with the fixed base, each including terminal slots; and conducting plates, each including at least one conducting terminal and a connecting terminal extended from an end of the conducting terminal, and the conducting plate is coupled with the fixed base and the insert connector, such that the conducting terminal is installed into the terminal slot and the connecting terminal is exposed from the fixed base. With the assembly of the fixed base and the insert connectors, and the conducting plate, the DC power output insert connector can be manufactured easily, and the manufacturing time and cost can be lowered. The invention also waives the soldering operation to comply with the environmental protection requirements, so as to lower the manufacturing and assembling costs and improve the competitiveness of the product.

### BACKGROUND OF THE INVENTION

1. Field of the Invention

The present invention generally relates to a power supply, and more particularly to a direct current (DC) power output insert connector of a power supply that can be manufactured and assembled conveniently to reduce manufacturing time and costs.

2. Description of the Related Art

Computers generally come with a power supply for converting a 110V or 220V AC power inputted from an external cable into a 12V, 5V or 3.3V DC power required by a hardware device such as a motherboard, a central processing unit (CPU) interface card and a data access unit (such as a hard disk drive, an optical disk drive, and a card reader, etc).

With reference to FIG. 1 for a traditional power supply, the power supply 90 comprises a main cable 91, a branch cable 92 and a plurality of output insert connectors 93, wherein the main cable 91 and the branch cable 92 are used for supplying electric power to the motherboard and CPU interface card, and the plurality of output insert connectors 93 are used as secondary cable devices to supply electric power to a hardware device of the data access unit (such as a hard disk drive, an optical disk drive, and a card reader, etc), and the plurality of output insert connectors 93 are fixed onto a printed circuit board (PCB) 94, and the printed circuit board 94 is coupled to an electric wire 97 through another electric wire 95 and a main circuit board 96 of a power supply 90 for outputting electric power, and the plurality of output insert connectors 93 are protruded outward from a plurality of through holes 99 on a rear panel 98 of the power supply 90 for connecting an insert connector 100 of another hardware device. Although the traditional power supply 90 can achieve the effect of supplying electric power to the computer hardware devices, there are drawbacks remained to be improved. For instance, it is necessary to manufacture the printed circuit board 94 first and then solder the plurality of output insert connectors 93 onto the printed circuit board 94 one by one in the process of manufacturing the secondary cable device. Since the manufacturing process involves several steps for connecting the rectifier circuit and soldering the insert connectors manually, it consumes more manufacturing time, manpower and cost for the manufacture and also incurs a higher material cost for a large quantity of solders, and thus the competitiveness of the product will be lowered. Obviously, the aforementioned arrangement is not good enough. On the other hand, it is a requirement and a tendency to avoid using the soldering operation for the environmental protection, and the manufacture of the traditional power supply 90 by using lots of solders should be improved as well. Therefore, it is a subject for the related industry to overcome the shortcomings of the manufacturing method of the traditional power output insert connectors.

In view of the shortcomings of the prior art, the inventor of the present invention based on years of experience in the related industry to conduct extensive researches and experiments, and finally developed a direct current output insert connector assembly of a power supply in accordance with the present invention, in hope of providing a convenient and cost-effective power supply to comply with the environmental protection requirements and promote the development of the related industry.

### SUMMARY OF THE INVENTION

Therefore, it is a primary objective of the present invention to provide a DC power output insert connector assembly of a power supply, and the DC power output insert connector of the power supply is easy to install and manufacture with a lower manufacturing cost, and no soldering operation is required in the manufacturing process to comply with the environmental protection requirements. The invention improved the cost-effectiveness, the manufacturing and assembling processes and the competitiveness of the product.

To achieve the foregoing objective, the present invention provides a DC power output insert connector assembly comprising: a fixed base; a plurality of insert connectors, coupled with the fixed base, and having a plurality of terminal slots; a plurality of conducting plates, having at least one conducting terminal and a connecting terminal extended from an end of the conducting terminal, and the conducting plate being coupled with the fixed base and the insert connector, such that the conducting terminal is installed in the terminal slot, and the connecting terminal is exposed from the fixed base.

The technical measures taken by the present invention comprises: a plurality of insert connectors, including a plurality of terminal slots; a plurality of conducting plates, each including at least one conducting terminal and a connecting terminal extended from an end of the conducting terminal, and the conducting terminal being disposed in the terminal slot, and arranged in a row; a circuit board, installed on the power supply, and having electronic components installed on the circuit board, and whose input power is rectified and supplied to a computer system and hardware devices, and the circuit board having an electric wire for outputting electric power, and the electric wire being coupled to the connecting terminal of the conducting plate; a fixing frame, including a plurality of fixing through holes for passing and positioning the insert connectors, and a positioning hole disposed separately on both sides of the fixing frame, and connected to an appropriate position of a casing of the power supply or inside a computer casing.

To make it easier for our examiner to understand the technical characteristics, features and effects of the present invention, preferred embodiments together with accompanying drawings are used for the detailed description of the invention as follows:

### BRIEF DESCRIPTION OF THE DRAWINGS

FIG. 1 is an exploded view of a conventional power supply assembly;

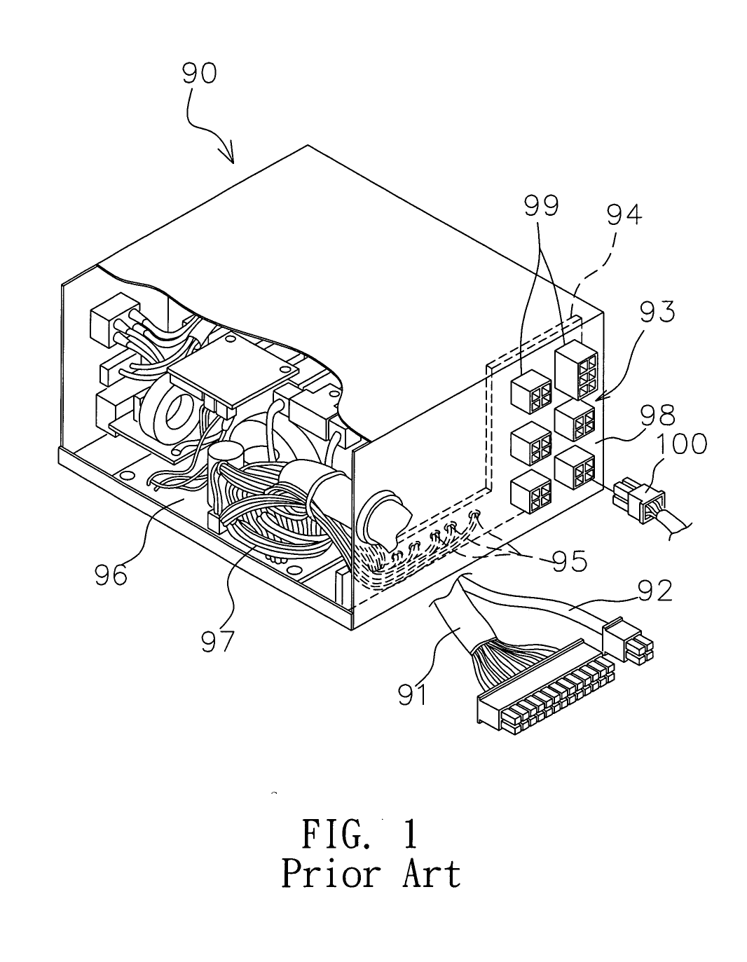

FIG. 2 is an exploded view of a first preferred embodiment of the invention;

FIG. 3 is a schematic view of a third cable device according to a first preferred embodiment of the invention;

FIG. 4 is a schematic view of a conducting plate according to a first preferred embodiment of the invention;

FIG. 5 is a perspective view of a third cable device according to a first preferred embodiment of the invention;

FIG. 6 is a schematic view of an application according to a first preferred embodiment of the invention;

FIG. 7 is a schematic view of an assembly according to a second preferred embodiment of the invention;

FIG. 8 is a schematic view of an assembly according to a third preferred embodiment of the invention; and

FIG. 9 is a schematic view of an assembly according to a fourth preferred embodiment of the invention.

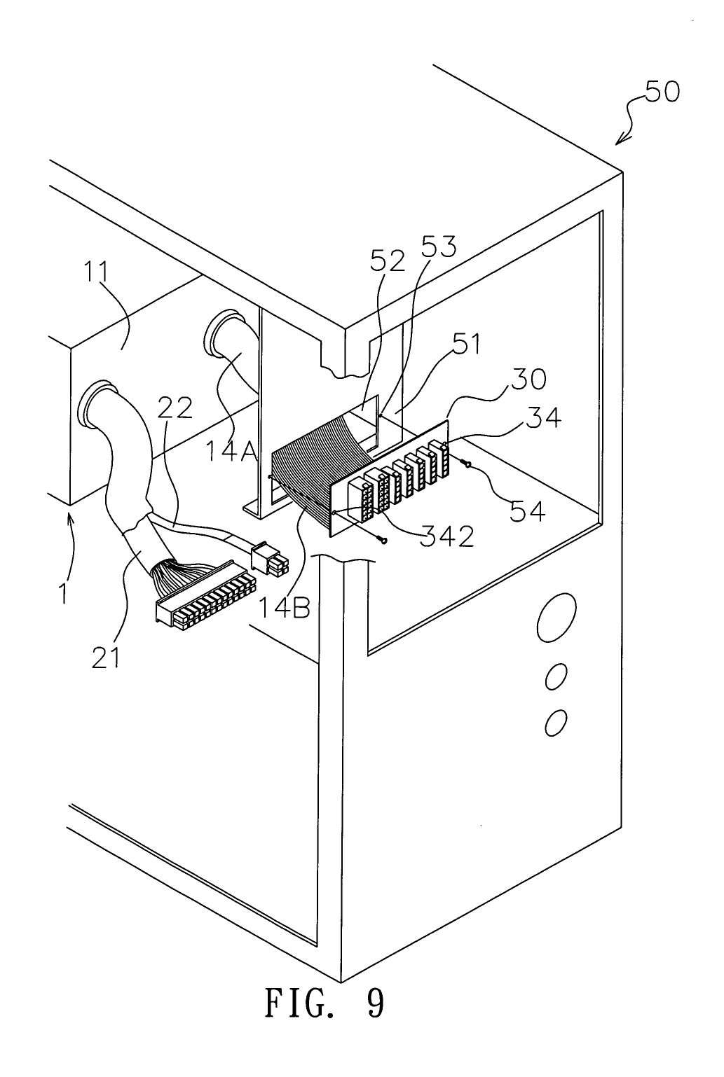

### DETAILED DESCRIPTION OF THE PREFERRED EMBODIMENTS

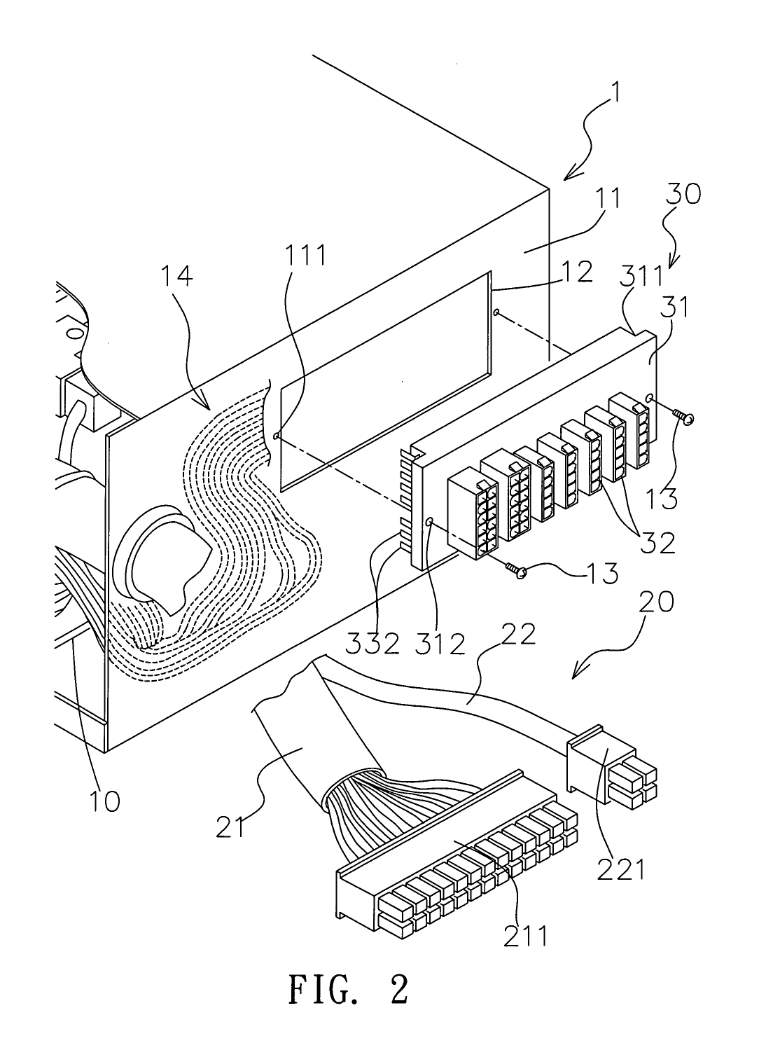

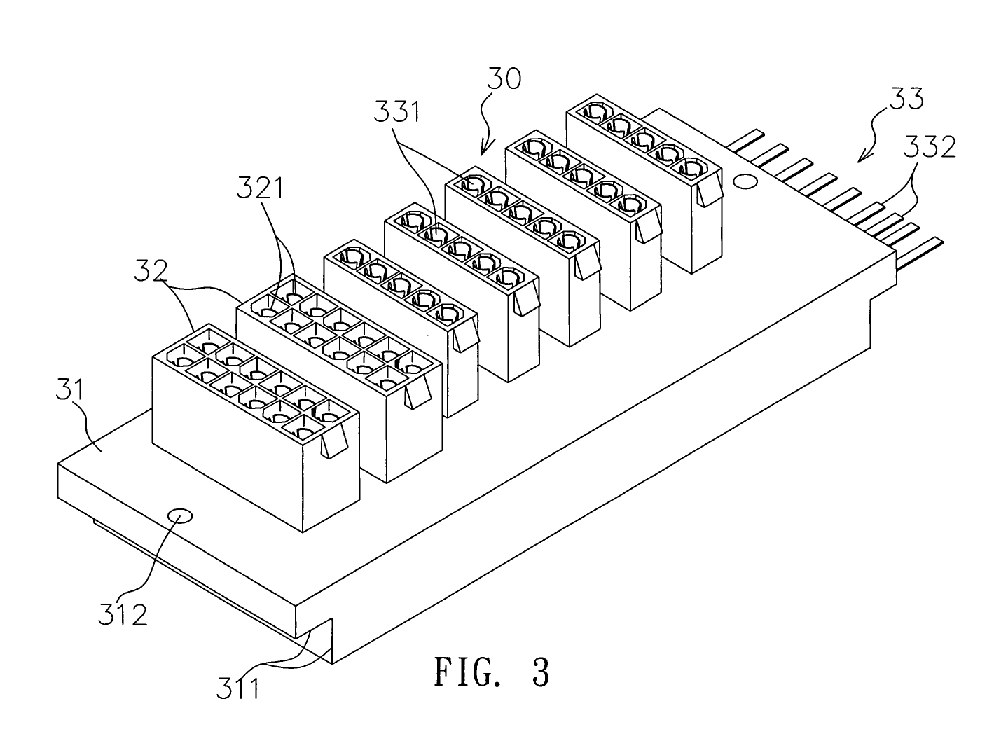

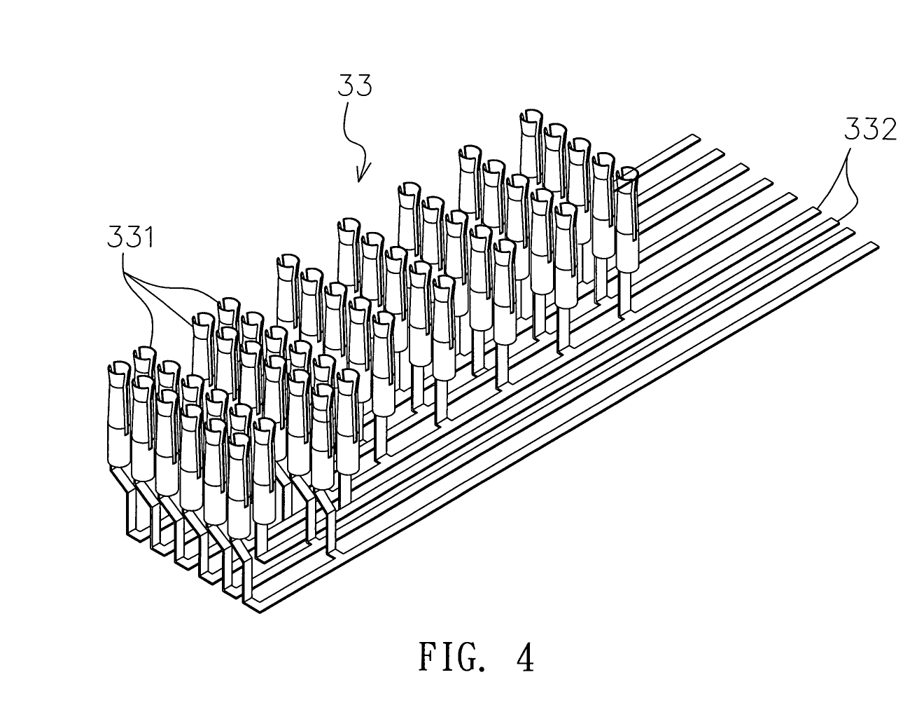

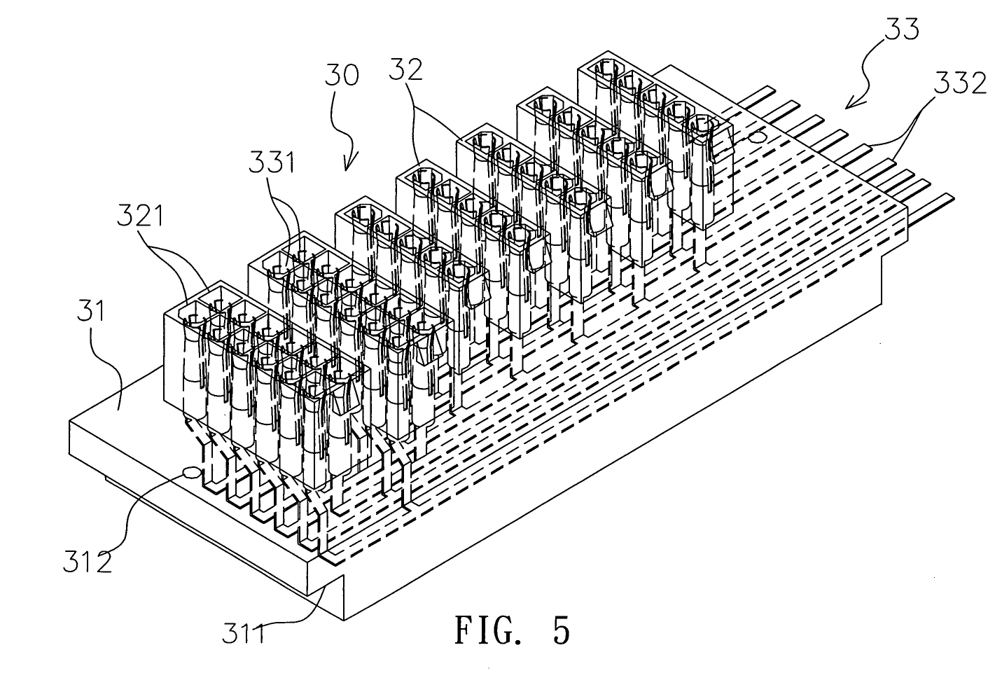

With reference to FIGS. 2 and 3 for a DC power output insert connector assembly of a power supply in accordance with a first preferred embodiment of the present invention, the insert connector refers to a socket or a plug and comprises a power supply 1, and the power supply 1 includes a circuit board 10 and a power output device 20. The circuit board 10 includes electronic components and rectifies and supplies the input power from the power output device 20 to the hardware devices of a computer system. The power output device 20 includes a first cable 21, a second cable 22 and a third cable device 30, and the first cable 21 and the second cable 22 are coupled to the circuit board 10, and whose output terminals include insert connectors 211, 221 (which are sockets in this embodiment) respectively, for connecting other hardware devices (not shown in the figure). The third cable device 30 is installed on a rear panel 11 of the power supply 1 and comprises a fixed base 31 and a plurality of insert connectors 32 (which are sockets in this embodiment), and the fixed base 31 includes a fixing cascade end 311 disposed separately on both sides of the fixed base 31 and a positioning hole 312, and the plurality of insert connectors 32 are blocks in different shapes and have a plurality of terminal slots 321 thereon, and the plurality of insert connectors 32 are coupled to the fixed base 31 and the plurality of conducting plates 33. With reference to FIG. 4 together, the conducting plate 33 is made by stamping a copper sheet and includes a plurality of conducting terminals 331 and a connecting terminal 332 extended from an end of the conducting terminal 331, and the conducting plate 33 is placed in a mold (not shown in the figure) and coupled to the fixed base 31 and the insert connector 32 (by an integral injection molding method in this embodiment), such that the conducting plate 33 is fixed and coupled to a predetermined position inside the fixed base 31, and the conducting terminal 331 is installed in the corresponding terminal slot 321, and the connecting terminal 332 is protruded or exposed, and arranged in a row on a side of the fixed base 31 as shown in FIG. 5.

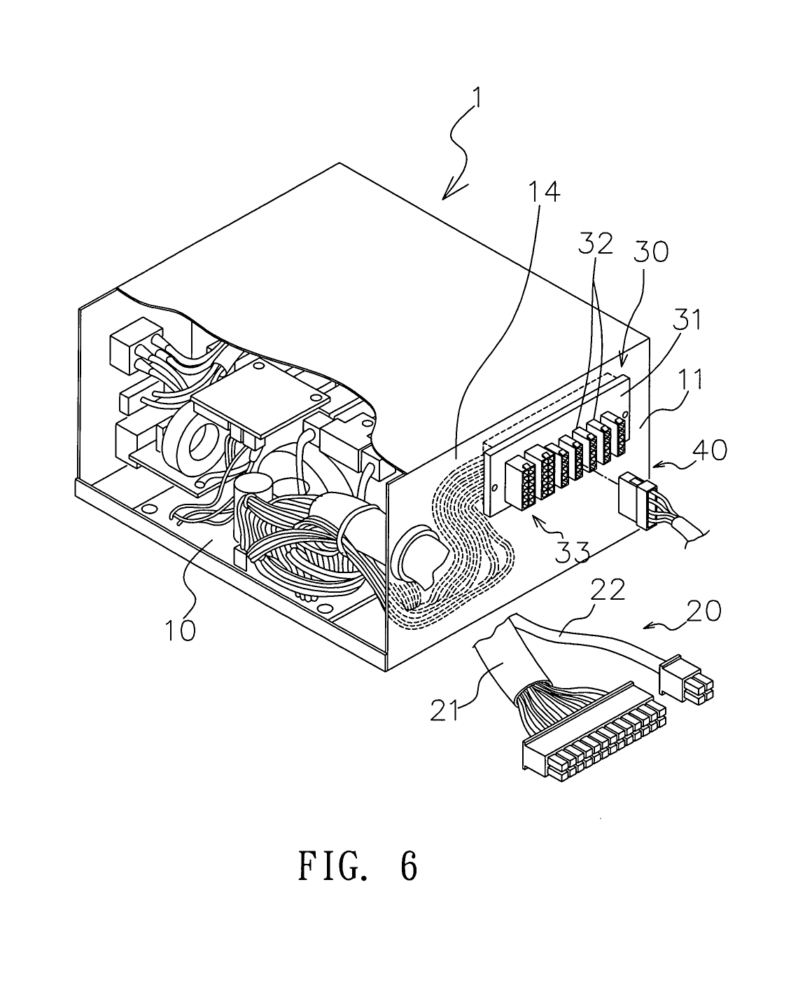

When the DC output power insert connector of a power supply in accordance with the present invention is assembled, the fixed base 31 is installed to the positioning window 12 of the rear panel 11, and the fixing cascade ends 311 of the fixed base 31 are abutted against both lateral sides of the positioning window 12 respectively, and a screw 13 is passed through the positioning hole 312 of the fixed base 31 and the positioning hole 111 of the rear panel 11 to screw the fixed base 31 onto the rear panel 11 as shown in FIG. 6, and then the electric wire 14 installed on the circuit board 10 for outputting electric power is connected to the connecting terminal 332 of the conducting plate 33 to constitute a connection to the power source for supplying electric power to the insert connector 40 (which is a plug in this embodiment) of another hardware device (such as a hard disk drive, an optical disk drive and a card reader, etc).

The DC power output insert connector of a power supply in accordance with the present invention is comprised of the fixed base 31 and the plurality of insert connectors 32 and integrally formed by an injection molding method to overcome the issue of connecting the plurality of insert connectors 32 to the fixed base 31 one by one, and the conducting plate 33 is coupled together with the fixed base 31 and the insert connector 32 to overcome the issue of having a time-consuming complicated process of soldering the plurality of insert connectors 32 onto a printed circuit board one by one, so that the DC power output insert connector of a power supply can be manufactured in an easy way to reduce the manufacturing cost. The present invention can achieve the effects of waiving the soldering operation, complying with the environmental protection requirements, lowering the manufacturing and assembling costs, and improving the competitiveness of the product.

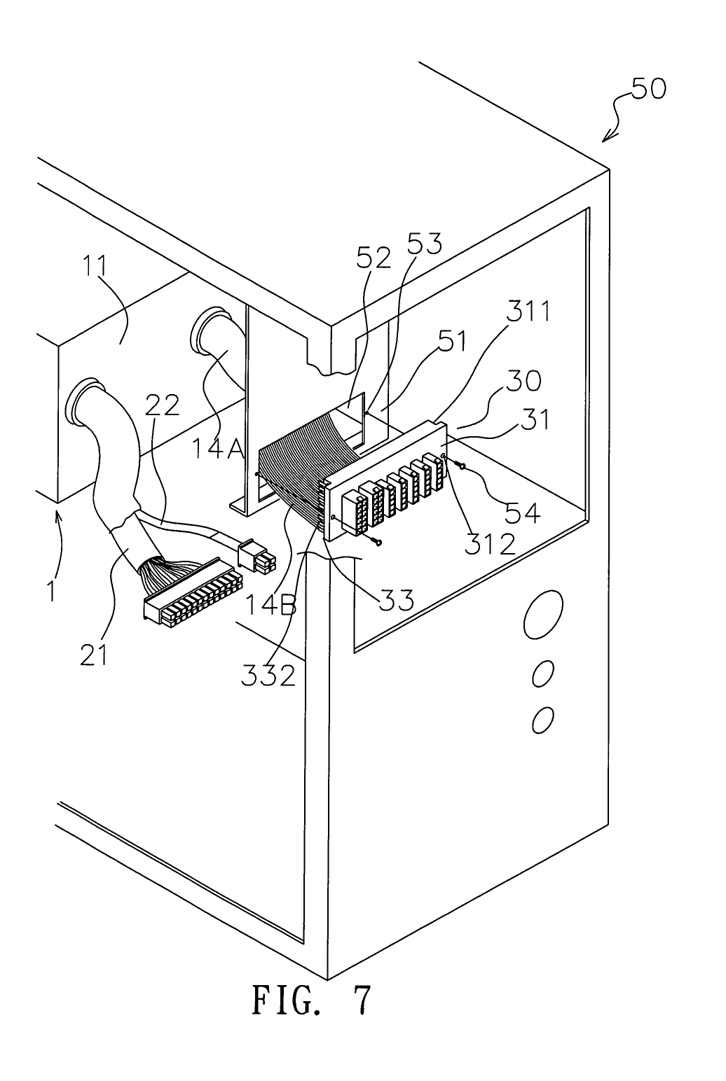

With reference to FIG. 7 for a DC power output insert connector assembly of a power supply in accordance with a second preferred embodiment of the present invention, the third cable device 30 is modified based on the basic structure of the first preferred embodiment, wherein the power supply 1 includes the first cable 21 extended from the power supply 1, the second cable 22 and a third cable device 14A extended from the power supply 1. In addition, an electric wire 14B is extended and connected to the third cable device 14A, or the electric wire 14B is extended directly from the power supply 1. Similarly, the electric wire 14B is coupled to the connecting terminal 332 of the conducting plate 33. A casing 50 (such as a computer casing) is used for installing the power supply, and a positioning plate 51 is disposed at an appropriate position inside the casing 50, and the positioning plate 51 includes a positioning window 52 and a positioning hole 53 disposed separately on both sides of the positioning window 52. During an assembling process, the fixed base 31 is installed to the positioning window 52 of the positioning plate 51, and the fixing cascade ends 311 of the fixed base 31 are abutted against both lateral sides of the positioning window 52 respectively, and then a screw 54 is passed through the positioning hole 312 of the fixed base 31 and the positioning hole 53 of the positioning plate 51 to screw the fixed base 31 onto the positioning plate 51. Since the third cable device 30 is not installed on the rear panel 11 of the power supply 1, but it is fixed at an appropriate spatial position in the casing 50, therefore the third cable device 30 is close to an insert element or device that requires a power source, for avoiding the situation of tangled cables.

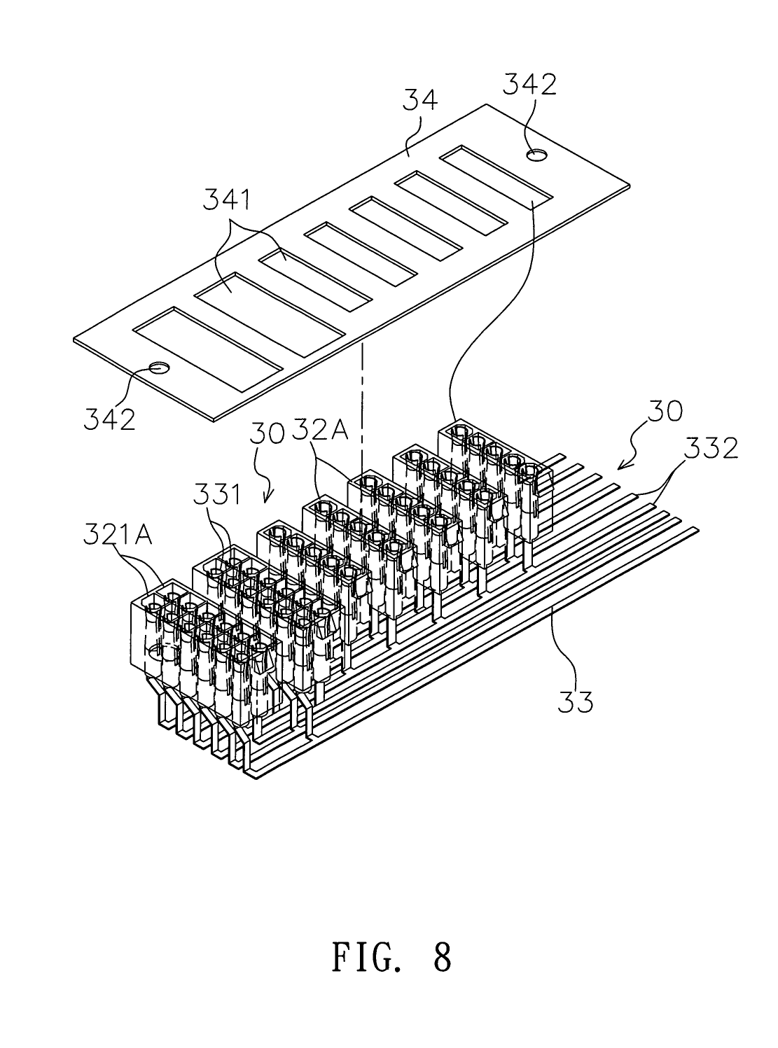

With reference to FIG. 8 for a DC power output insert connector assembly of a power supply in accordance with a third preferred embodiment of the present invention, the third cable device 30 comprises a plurality of insert connectors 32A and a plurality of conducting plates 33, and the plurality of insert connectors 32A can be of different types and include a plurality of terminal slots 321A thereon, and the conducting plate 33 can be made by stamping a copper sheet and includes a plurality of conducting terminals 331 and a connecting terminal 332 extended from an end of the conducting terminal 331. The conducting terminal 331 of the conducting plate 33 is installed in the terminal slot 321A, and the connecting terminals 332 are arranged in a row. A fixing frame 34 is substantially in the shape of a plate and includes a plurality of fixing through holes 341 and a positioning hole 342 disposed separately on both sides of the fixing frame 34. The fixing through hole 341 is provided for passing and fixing the insert connector 32A to couple the insert connector 32A, and the fixing frame 34 of the conducting plate 33 is fixed to a casing of the power supply or at an appropriate position inside a computer casing by the positioning hole 342. Since the insert connector 32A is a common device used extensively in the industry and the manufacture requires no additional cost for the mold, therefore the cost of the foregoing application can be reduced significantly.

With reference to FIG. 8 for a DC power output insert connector assembly of a power supply in accordance with a fourth preferred embodiment of the present invention, the device of the third preferred embodiment is installed in a casing 50 (such as a computer casing), and a positioning plate 51 is installed at an appropriate position in the casing 50, and the positioning plate 51 includes a positioning window 52 and a positioning hole 53 disposed separately on both sides of the positioning window 52. During an assembling process, the fixing frame 34 is installed to the positioning window 52 of the positioning plate 51, and the positioning holes 342 on both sides of the fixing frame 34 are abutted against both sides of the positioning window 52 respectively, and then a screw 54 is passed through the positioning hole 342 of the fixing frame 34 and the positioning hole 53 of the positioning plate 51 to screw the fixing frame 34 onto the positioning plate 51. Since the third cable device 30 is not installed onto the rear panel 11 of the power supply 1, but is fixed at an appropriate spatial position in the casing 50, therefore the third cable device 30 is close to an insert element or device that requires a power source for avoiding the situation of tangled cables.

In summation of the above description, the present invention herein enhances the performance than the conventional structure and further complies with the patent application requirements and is duly filed for patent application. While the invention is described in some detail hereinbelow with reference to certain illustrated embodiments, it is to be understood that there is no intent to limit it to those embodiments. On the contrary, the aim is to cover all modifications, alternatives and equivalents falling within the spirit and scope of the invention as defined by the appended claims.

What is claimed is:

1. A DC power output insert connector assembly of a power supply, comprising:
a fixed base;
a plurality of insert connectors, integrated with said fixed base, and said insert connectors having a plurality of terminal slots;
a plurality of conducting plates, having at least one conducting terminal with an end coupled to said conducting plate and said fixed base for connecting said insert connector and allowing said conducting terminal to be installed in said corresponding terminal slot and said connecting terminal to be exposed from said fixed base;
a circuit board, installed on a power supply, for rectifying and supplying an input power source to a hardware device, and said circuit board including an electronic component, and said circuit board including an electric wire for outputting electric power, and said electric wire being coupled to said connecting terminal of said conducting plate.

2. The DC power output insert connector assembly of a power supply according to claim 1, wherein said power supply further comprises a rear panel, and said rear panel comprises a positioning window for fixing said fixed base.

3. The DC power output insert connector assembly of a power supply according to claim 1, wherein said fixed base comprises a fixing cascade end disposed on a side of said fixed base, and a positioning hole.

4. The DC power output insert connector assembly of a power supply according to claim 1, wherein said conducting plate is formed by stamping a copper sheet.

5. The DC power output insert connector assembly of a power supply according to claim 4, wherein said conducting plate is placed in a mold and integrally formed with said fixed base and said insert connector by an injection molding, such that said conducting plate is fixed at a predetermined position in said fixed base.

6. The DC power output insert connector assembly of a power supply according to claim 5, wherein said connecting terminal of said conducting plate is protruded from a side of said fixed base and arranged in a row.

7. The DC power output insert connector assembly of a power supply according to claim 2, wherein said rear panel comprises a positioning hole disposed on a side of said positioning window.

8. The DC power output insert connector assembly of a power supply according to claim 2, wherein said fixed base is screwed onto said rear panel and disposed at the position of said positioning window.

9. The DC power output insert connector assembly of a power supply according to claim 2, wherein said insert connector is provided for inserting a plug for supplying electric power.

10. The DC power output insert connector assembly of a power supply according to claim 1, wherein said fixed base is disposed in a casing, and said casing comprises a positioning plate, and said positioning plate comprises a positioning window for fixing said fixed base.

11. The DC power output insert connector assembly of a power supply according to claim 10, wherein said positioning window includes a positioning hole disposed separately on both sides of said positioning window for a connection by a screw.

12. The DC power output insert connector assembly of a power supply according to claim 10, wherein said power supply comprises an electric wire extended from said power supply and connected with a connecting terminal of said conducting plate.

13. The DC power output insert connector assembly of a power supply according to claim 12, further comprising a third cable device installed between said electric wire and said power supply.

14. A DC power output insert connector assembly of a power supply, comprising: a fixing frame, substantially in a plate shape, and having a plurality of fixing through holes;
a plurality of insert connectors, coupled with said fixing through holes on said fixing frame, and said insert connector including a plurality of terminal slots;
a plurality of conducting plates, including at least one conducting terminal and a connecting terminal extended from an end of said conducting terminal, and said conducting terminal being disposed in said terminal slot, and arranged in a row;
a circuit board, installed on a power supply, for rectifying and supplying an input power source to a hardware device, and said circuit board including an electronic component, and said circuit board including an electric wire for outputting electric power, and said electric wire being coupled to said connecting terminal of said conducting plate.

15. The DC power output insert connector assembly of a power supply according to claim 14, further comprising a positioning hole disposed separately on both sides of said fixing frame and provided for fixing a casing of said power supply.

16. The DC power output insert connector assembly of a power supply according to claim 14, wherein said conducting plate is formed by stamping a copper sheet.

17. The DC power output insert connector assembly of a power supply according to claim 14, wherein said fixed base is disposed in a casing, and said casing comprises a positioning plate, and said positioning plate comprises a positioning window for fixing said fixed base.

18. The DC power output insert connector assembly of a power supply according to claim 17, further comprising a positioning hole disposed separately on both sides of said positioning window and provided for a connection by a screw.
